(19) United States
(12) Patent Application Publication
(10) Pub. No.: US 2015/0345875 A1
(43) Pub. Date: Dec. 3, 2015

(54) FLAT TUBE FOR A CHARGE AIR HEAT EXCHANGER AND CORRESPONDING CHARGE AIR HEAT EXCHANGER

(71) Applicant: VALEO SYSTEMES THERMIQUES, Le Mesnil-Saint-Denis (FR)

(72) Inventor: Nicolas Vallee, Bazancourt (FR)

(73) Assignee: Valeo Systemes Thermiques, Le Mesnil Saint Denis (FR)

(21) Appl. No.: 14/652,321

(22) PCT Filed: Dec. 18, 2013
(86) PCT No.: PCT/EP2013/077240

§ 371 Date: Jun. 15, 2015

(30) Foreign Application Priority Data
Dec. 18, 2012 (FR) 1262264

(51) Int. Cl. F28F 1/00; B23P 15/26

(52) U.S. Cl. CPC F28F 1/003; B23P 15/26

(57) ABSTRACT

A flat tube of a charge air heat exchanger, produced from at least one metal sheet that has been pressed to form an exchange plate, the pressing allowing a fluid inlet and a fluid outlet to be connected by a circuit through which a heat-transfer fluid circulates. The circuit includes at least one fluid circulation path having at least two passes which are separated by a rib, where the rib has at least one zone of lower heat exchange between two adjacent passes of the fluid circulation path. Embodiments disclosed herein also relate to the method of manufacturing the flat tube and to the heat exchanger having such a flat tube.

The invention relates to the field of heat exchangers and more particularly of charge air heat exchangers used in the automotive field.

It is a known practice in the field of motor vehicles to use heat exchangers comprising a stack of identical flat tubes through which a first fluid circulates. Each flat tube is generally formed of two sheet-metal plates that are pressed in order to form a dish in a predefined pattern, and arranged in such a way that their concavities face one another. The two plates are then joined together in a fluidtight manner, thus forming a flat tube through which the first fluid can circulate from a fluid inlet toward a fluid outlet, each one situated at one end of the flat tube and more generally each one situated on opposite sides of the plate.

The flat tubes are stacked on top of one another, with the fluid inlets of each flat tube being joined together to form an inlet riser. Likewise, the fluid outlets of each flat tube are joined together to form an outlet riser. Between each flat tube is left a space for the passage of a second fluid. Exchange of heat between the two fluids then takes place as the first fluid passes through the flat tubes and the second fluid passes between said flat tubes.

Such heat exchangers are commonly used as evaporators in a refrigerant circuit for air conditioning the interior of a motor vehicle, this refrigerant constituting the first fluid and the second fluid being atmospheric air or as a heater in a heat-transfer fluid circuit for heating the cabin of a motor vehicle, this heat transfer fluid constituting the first fluid, and the second fluid being atmospheric air.

Nevertheless, such exchangers may prove ill-suited to use in a charge air intake circuit in which the thermal parameters are quite special. Specifically, before entering the combustion cylinders, the compressed and heated intake air needs to be cooled sufficiently by means of a heat exchanger in order to reduce the risks of self ignition, this being something that a conventional heat exchanger is unable to achieve effectively.

Thus, one of the objects of the invention is to at least partially remedy the disadvantages of the prior art and propose an improved charge air heat exchanger.

The present invention therefore relates to a flat tube of a charge air heat exchanger, produced from at least one metal sheet that has been pressed to form an exchange plate, said pressing allowing a fluid inlet and a fluid outlet to be connected by a circuit through which a heat-transfer fluid circulates, said circuit comprising at least one fluid circulation path comprising at least two passes which are separated by a rib, said rib comprising at least one zone of lower heat exchange between two adjacent passes of the fluid circulation path.

This at least one zone of lower heat exchange allows the adjacent passes to be isolated and limits exchanges of heat between said passes, thereby increasing the effectiveness of the heat exchanger.

According to one aspect of the invention, said flat tube is formed by the assembly of two heat-exchange plates which have been produced from a pressed metal sheet and assembled with one another, the pressed sides of each exchange plate facing each other.

According to another aspect of the invention, the at least one zone of less heat exchange between two adjacent passes of the circulation path is produced by thinning the material at the rib or ribs.

According to another aspect of the invention, the at least one zone of less heat exchange between two adjacent passes of the circulation path is produced by a slot in the rib or ribs.

According to another aspect of the invention, said flat tube comprises a single zone of lower heat exchange between two adjacent passes of the circulation path of a length substantially equal to the length of the rib on which it is achieved.

According to another aspect of the invention, said flat tube comprises a plurality of zones of lower heat exchange between two adjacent passes of the circulation path which are distributed along the rib on which it is produced.

The present invention also relates to a method of manufacturing a flat tube of heat exchanger, comprising the following steps:
pressing at least one metal sheet to form at least one exchange plate comprising a circuit connecting a fluid inlet and a fluid outlet, said circuit comprising said circuit comprising at least one fluid circulation path comprising at least two adjacent passes separated by a rib,
creating at least one zone of lower heat exchange on the ribs between two adjacent passes of the fluid circulation path,
closing the flat tube.

According to one aspect of the method according to the invention, the step of creating the at least one zone of lower heat exchange between two adjacent passes is performed during the pressing of the metal sheet in order to form an exchange plate.

According to another aspect of the method according to the invention, the step of creating the at least one zone of lower heat exchange between two adjacent passes is performed by laser cutting of the exchange plate.

The invention also relates to a charge air heat exchanger comprising at least one flat tube as described hereinabove or obtained by a method of manufacturing a flat tube as described hereinabove.

According to one aspect of the invention, said exchanger comprises, on each side of at least one flat tube, a perturbator of the flow of a second heat-transfer fluid, and said perturbator also comprises, facing the ribs, at least one zone of lower heat exchange.

Further features and advantages of the invention will become more clearly apparent from reading the following description given by way of illustrative and non-limiting example, in which:

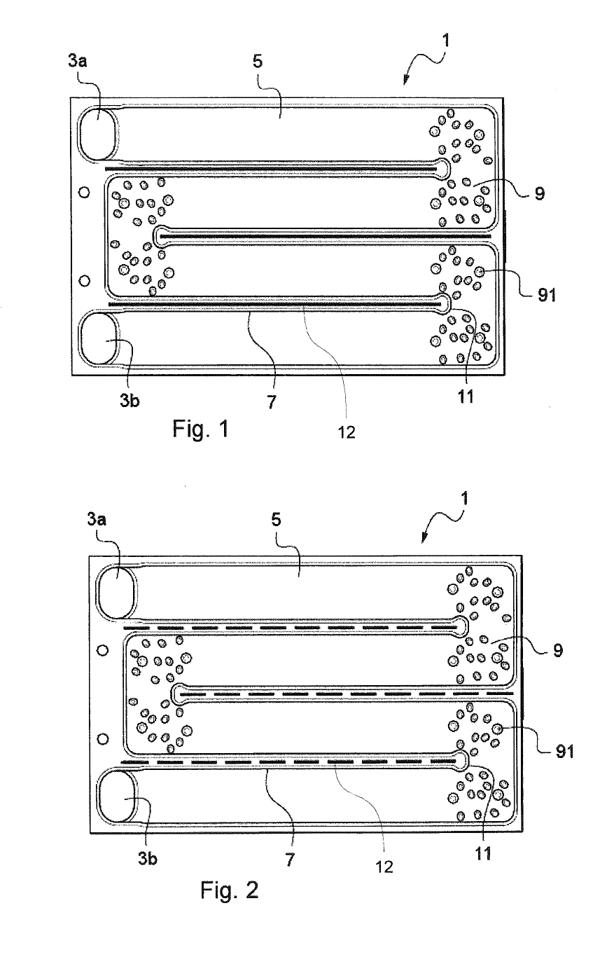

FIGS. 1 and 2 are a schematic depiction of an exchange plate according to two distinct embodiments,

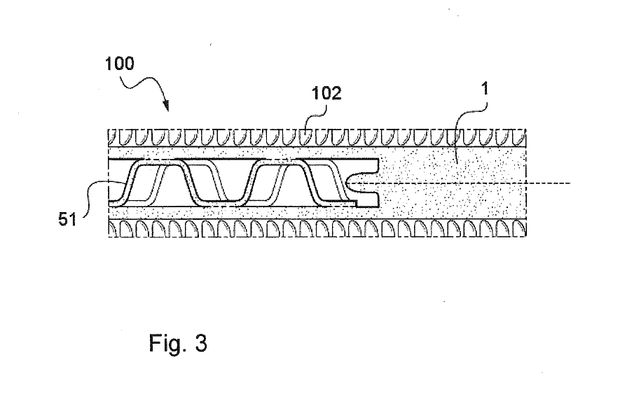

FIG. 3 is a schematic depiction in cross section of a flat tube.

In the various figures, identical elements bear similar references.

The exchange plate 1 for a flat tube of a heat exchanger, depicted in FIGS. 1 and 2, can be produced from a pressed metal sheet. It comprises a fluid inlet 3a and a fluid outlet 3b. The pressing of the exchange plate 1 forms a cavity with ribs 7 defining a flow circuit for fluid to flow between the fluid inlet 3a and the fluid outlet 3b.

The ribs 7 give the flow circuit a path for the circulation of a first heat-transfer fluid between the fluid inlet 3a and the fluid outlet 3b. This circulation path comprises at least two rectilinear passes 5 connected by a curved portion 9. This circulation path allows an increase in the length of the flow circuit and therefore increases the time for which the first heat-transfer fluid flows within it, thereby increasing the length of time for which there can be a transfer of heat with respect to a second fluid circulating on the opposite face of the exchange plate 1. To facilitate this flow of the first heat-transfer fluid, the ribs 7 may have rounded ends 11.

The ribs 7 also comprise at least one zone 12 of lower heat exchange between two adjacent passes 5 of the fluid circulation path. This at least one zone 12 of lower heat exchange may be a slot passing through the exchange plate 1 at the rib or ribs 7 or alternatively may be a thinning of material at the rib or ribs 7. This at least one zone 12 of lower heat exchange allows isolation between adjacent passes 5 and limits the exchanges of heat between said passes 5, thereby increasing the effectiveness of the heat exchanger. That is particularly advantageous in the case of a charge air heat exchanger in which the first fluid is compressed hot air and which therefore needs to be cooled sufficiently in order to reduce the risks of self ignition.

In the example set out in FIGS. 1 and 2, the plate 1 comprises four mutually parallel passes 5 and three curved portions 9 making the connection between said passes 5.

According to a first embodiment illustrated in FIG. 1, an exchange plate 1 and therefore a flat tube 100 comprises a single zone 12 of lower heat exchange between two adjacent passes 5, this zone 12 of lower heat exchange having a length substantially equal to that of the rib 7 on which it is made. In this example illustrated by FIG. 1, there are three ribs 7 each bearing a single zone 12 of lower heat exchange.

According to a second embodiment illustrated in FIG. 2, an exchange plate 1 and therefore a flat tube 100 comprises a plurality of zones 12 of lower heat exchange between two adjacent passes 5, this plurality of zones 12 of lower heat exchange being distributed over a length substantially equal to that of the rib 7 on which it is made. In this example illustrated in FIG. 2, there are three ribs 7 each bearing a plurality of zones 12 of lower heat exchange.

As FIG. 1 shows, the at least one curved portion 9 may have projections 91. These projections 91 may be formed as an integral part of the at least one heat exchange plate 1, for example being produced by pressing, or they may alternatively be elements attached and fixed inside the at least one curved portion 9 using any means known to those skilled in the art.

The flat tubes 100 are generally made up by assembling two exchange plates 1 with one another, the passes 5 and curves 9 of the circuits and the ribs 7 of each of the two exchange plates 1 facing one another, forming the circulation path of said flat tube 100. The exchange plates 1 are assembled in a fluidtight manner, for example using brazing, so as to avoid any leaks of heat-transfer fluid passing along the flat tube 100. Such flat tubes 100 are relatively slender; for example, the circulation path thereof may have a height from 1 mm to 3 mm.

Another way of embodying a flat tube 100 may be to assemble an exchange plate 1 with a flat plate resting on the periphery of the exchange plate 1 and on the ribs 7, covering the flow circuit.

As shown by FIG. 2, inside the flat tube 100, the circuit comprises at least one insert 51 intended to perturb the circulation of the first heat-transfer fluid and create turbulence, and to increase the area of contact with the first heat-transfer fluid and therefore increase exchanges between said first fluid and the flat tube 100. The at least one insert 51 may be made of metal and may thus be fixed to the walls of the flat tube 100 using brazing.

The insert 51 may have a corrugated configuration at right angles to the direction of flow of the first heat-transfer fluid, the ends of each corrugation being in contact with the walls of the flat tube 100. The insert 51 may also, parallel to the direction in which the heat-transfer fluid circulates along the flat tube 100, have series of corrugated sections which are offset from one another at right angles to the direction in which the heat-transfer fluid circulates. The first heat-transfer fluid therefore passes between the corrugations of each section, increasing the area for contact and exchange between the fluid and the walls of the flat tube 100, and as it passes from one corrugated section to another, the first heat-transfer fluid is perturbed thereby allowing the temperature to be evened out and ensuring better efficiency of heat exchange with the flat tube 100.

Of course, said insert 51 may equally have other shapings allowing an increase in the area of contact and allowing the fluid to be evened out, such as a square wave form, zig zags or even louvers.

A heat exchanger with flat tube 100 also comprises a stack of flat tubes 100 joined together at their fluid inlet and outlet 3a and 3b, and each flat tube 100 being spaced away so as to allow a second fluid to pass between said flat tubes 100. The flat tubes 100 are joined together at the fluid inlet and outlet 3a, 3b to form a fluid inlet riser grouping together all the fluid inlets of all the flat tubes 100 and a fluid outlet riser grouping together all the fluid outlets of all the flat tubes 100. To facilitate the exchange of heat between the first heat-transfer fluid circulating through the flat tubes 100 and the second fluid passing between said flat tubes 100 it is also possible to add, on each side of the flat tube 100 perturbators 102 such as fins in the space between two flat tubes 100.

The use of attached components by way of inserts 51 in the passes 5 of the flat tubes 100 allows the latter to have a smooth wall which therefore makes attaching perturbators 102, for example by brazing, into the space between two flat tubes 100 easier.

The perturbators 102 may, in the manner of the ribs 7, have at least one zone of lower heat exchange (these are not depicted) facing said ribs 7.

The method of manufacturing such flat tubes 100 may comprise the following steps:

a first step of pressing at least one metal sheet in order so as to form at least one exchange plate 1 comprising a circuit connecting a fluid inlet 3a and a fluid outlet 3b, said circuit comprising said circuit comprising at least one fluid circulation path comprising at least two passes 5 separated by a rib 7.

The second step of the method of manufacture involves creating at least one zone 12 of lower heat exchange on the ribs 7 between two adjacent passes 5 of the fluid circulation path. This second step may be performed during the first step of pressing the at least one metal sheet so as in order to form at least one exchange plate 1, or alternatively. This second step may also be performed by laser curing of the exchange plate following the first step.

An intermediate step in the method of manufacture may be to fit at least one insert 51 in the region of the passes 5 as described above.

A third step in the method of manufacture is to close the flat tube 100. As outlined above, this step is preferably performed by assembling two exchange plates 1 produced from a pressed metal sheet and assembled with one another with the pressed sides of each exchange plate 1 facing one another.

During this third step, the exchange plates 1 are fixed together hermetically, for example using brazing. This method of attachment using brazing also allows the at least one insert 51 to be fixed, inside the flat tube 100, against the internal walls of the flat tube 100 and also allows the projections 91 that face one another to be fixed.

Thus it can be clearly seen that the flat tube 100 according to the invention allows optimal exchange of heat between a first heat-transfer fluid circulating within it and a second fluid on the outside, and does so by virtue of the presence of zones 12 of lower heat exchange which limit the exchanges of heat between the adjacent passes 5 and thus improve the effectiveness of the heat exchanger.

1. A flat tube of a charge air heat exchanger, produced from at least one metal sheet that has been pressed to form an exchange plate, said pressing allowing a fluid inlet and a fluid outlet to be connected by a circuit through which a heat-transfer fluid circulates, said circuit comprising at least one fluid circulation path comprising at least two passes which are separated by a rib, wherein said rib comprises at least one zone of lower heat exchange between two adjacent passes of the fluid circulation path.

2. The flat tube as claimed in claim 1, wherein said flat tube is formed by the assembly of two exchange plates which have been produced from a pressed metal sheet and assembled with one another, the pressed sides of each exchange plate facing each other.

3. The flat tube as claimed in claim 1, wherein the at least one zone of lower heat exchange between two adjacent passes of the circulation path is produced by thinning the material at the rib or ribs.

4. The flat tube as claimed in claim 1, wherein the at least one zone of lower heat exchange between two adjacent passes of the circulation path is produced by a slot in the rib or ribs.

5. The flat tube as claimed in claim 1, further comprising a single zone of lower heat exchange between two adjacent passes of the circulation path of a length substantially equal to the length of the rib on which it is achieved.

6. The flat tube as claimed in claim 1, characterized in that it comprises a plurality of zones of lower heat exchange between two adjacent passes of the circulation path which are distributed along the rib on which it is produced.

7. A method of manufacturing a flat tube of heat exchanger, comprising:
pressing at least one metal sheet to form at least one exchange plate comprising a circuit connecting a fluid inlet and a fluid outlet, said circuit comprising at least one fluid circulation path comprising at least two adjacent passes separated by a rib;
creating at least one zone of lower heat exchange on the ribs between two adjacent passes of the fluid circulation path; and
closing the flat tube.

8. The method of manufacture as in claim 7, wherein the step of creating the at least one zone of lower heat exchange between two adjacent passes is performed during the pressing of the metal sheet in order to form an exchange plate.

9. The method of manufacture as claimed in claim 7, wherein the step of creating the at least one zone of lower heat exchange between two adjacent passes is performed by laser cutting of the exchange plate.

10. A charge air heat exchanger comprising at least one flat tube as claimed in claim 1.

11. The charge air heat exchanger as claimed in claim 10, wherein said exchanger comprises, on each side of at least one flat tube, a perturbator of the flow of a second heat-transfer fluid, and wherein said perturbator also comprises, facing the ribs, at least one zone of lower heat exchange.
